(19) United States
(12) Patent Application Publication
(10) Pub. No.: US 2002/0178427 A1
(43) Pub. Date: Nov. 28, 2002

(54) Method for improving timing behavior in a hardware logic emulation system

(76) Inventors: Cheng-Liang Ding, Cupertino, CA (US); Thomas H. Freeman, Sunnyvale, CA (US); Liang-Fang Chao, Cupertino, CA (US); Tzvi Ben-Tzur, Sunnyvale, CA (US)

Correspondence Address: LYON & LYON LLP, 633 WEST FIFTH STREET, SUITE 4700, LOS ANGELES, CA, 90071, US

(21) Appl. No.: 09/865,873

(22) Filed: May 25, 2001

(51) Int. Cl. G06F 9/455

(52) U.S. Cl. 716/12

(57) ABSTRACT

A method and apparatus for shortening the time to emulation and user-friendliness of a hardware emulation system is disclosed that places adjustable delay elements at the inputs to each flip-flop in a design after the user's design has been compiled. The user selects the amount of delay to be programmed into the adjustable delay element.

### BACKGROUND OF THE INVENTION

1. Technical Field

The present invention relates in general to hardware logic emulation systems for verifying electronic circuit designs and more specifically to methods for improving the timing behavior of such systems.

2. Background of the Related Art

Hardware emulation systems are devices designed for verifying electronic circuit designs prior to fabrication as chips or printed circuit boards. These systems are typically built from programmable logic chips (logic chips). Most commercially successful hardware emulation systems also use programmable interconnect chips (interconnect chips). The term “chip” as used herein refers to integrated circuits. Hardware logic emulation systems are typically (although not exclusively) used in the following manner. First, a circuit designer designs a logic circuit (which can have many millions of logic gates, logic gates being the building blocks of digital electronic circuits). After the design of such a circuit, the circuit designer often would like to determine whether their design is functionally correct, i.e., that the design functions as the designer had intended. There are many such tools that can be used for functional verification, including software simulation and hardware logic emulation.

Hardware logic emulation systems take a user's design, process the design (sometimes referred to a “compilation”), and then program the programmable logic chips and programmable interconnect chips (if present) with actual logic functions. Because the hardware emulation system is programmed with actual logic resources from the user's design, the user's design can be used in an actual operating environment (sometimes referred to as the “target system”). In addition, because actual hardware is being created, hardware logic emulation systems operate at much higher speeds than other verification methods such as event driven software simulation. Exemplary hardware logic emulation systems can be seen in U.S. Pat. Nos. 5,109,353, 5,036,473, 5,448,496 and 5,960,191, the disclosures of which are incorporated herein by reference in their entirety. Exemplary logic chips used in hardware emulation systems include off the shelf field programmable gate arrays (“FPGAs”) from vendors such as Xilinx, Inc., San Jose, Calif. Additionally, logic chips specifically designed for hardware emulation systems can be used. Exemplary custom logic chips include such logic chips disclosed in co-pending U.S. patent application Ser. No. 08/968,401 (Lyon & Lyon Docket No. 220/290) and Ser. No. 09/570,142 (Lyon & Lyon Docket No. 254/063), which are assigned to the assignee of the present inventions. U.S. patent application Ser. Nos. 08/968,401 and 09/570,142 are hereby incorporated herein by reference in their entirety.

The user's design is provided in the form of a netlist description of the design. A netlist description (or “netlist”, as it is referred to by those of ordinary skill in the art) is a description of the integrated circuit's components and electrical interconnections between the components. The components include all those circuit elements necessary for implementing a logic circuit, such as combinational logic (e.g., gates) and sequential logic (e.g., flip-flops and latches). In prior art emulation systems such as those manufactured and sold by Quickturn Design Systems, Inc., San Jose, Calif., the netlist is compiled such that is placed in a form that can be programmed into the programmable resources of the emulation system. Thus, after compilation, the netlist description of the user's design has been processed such that an “emulation netlist” is created. An emulation netlist is a netlist that can be programmed into the programmable resources of the emulation system.

The timing characteristics of the user's logic design is very important to the design and is given a tremendous amount of attention during the design phase. The timing characteristics of that same design when programmed into the hardware logic emulation system, however, is often changed from the timing characteristics of the design. This is caused in large part by the fact that the user's design had to be partitioned into significantly smaller partitions and programmed into many (often times, hundreds) of programmable integrated circuits.

One example of a timing error that may develop in a hardware logic emulation system is a hold time violation. A hold time violation can occur if a transmitting device removes a data signal before a receiving device had properly saved it into a flip-flop or latch. Thus, the D input of a flip-flop must be stable for a short time both before and after a gating edge transition of the flip-flop's clock pin. The required time before clock transition is called the setup-time, and the required time after the edge transition is called the hold-time. This problem will be more fully explained with reference to FIG. 1. In the example of FIG. 1, a setup-time violation will occur on flip-flop two (“FF2”) 12 if the output of flip-flop one (“FF1”) 10 does not have enough time to propagate through logic C1 network 14 before the next clock-edge arrives on FF2 12.

Setup-time violations can be avoided by simply running a system clocks of a design at a slow enough rate. A hold time violation will occur if the output of FF1 10 propagates through logic network C1 14 before the clock (“CLK”) signal propagates through logic network C2 16. Hold-time violations can be avoided by introducing a delay at the input of FF2 12. Prior art methods of handling timing problems in hardware emulation systems are disclosed in U.S. Pat. Nos. 5,452,239 and 5,475,830, the disclosures of which are incorporated herein by reference in their entirety.

Prior art methods of eliminating hold time violations dealt with the problem while the design was being compiled. One such a prior art solution is disclosed in U.S. Pat. No. 5,475,830 mentioned above. Prior art emulation compilers such as the Quest II software from Quickturn Design Systems, Inc., San Jose, Calif., compiled the user's circuit design for emulation using a method that attempts to make the resulting emulation free from hold-time violations on flip-flops. With reference again to FIG. 1, the prior art method of reducing or eliminating hold time violations will be discussed. In FIG. 1, two edge-triggered flip-flops 10, 12 are separated by some combinatorial logic 14. If you assume that the designer's intent was for the clock transitions at the flip-flop 10, 12 clock inputs to be simultaneous, it is plain that this will not happen because the clock signal CLK going through logic network C2 16 will arrive at flip flop FF2 12 later than the clock signal CLK arrives at flip-flop FF1 10. Another way of saying this is the delay through logic network C1 14 is assumed to be greater than the delay through logic network C2 16.

In the prior art, emulation software used for compilation analyzed the clock tree of the circuit to be emulated in an attempt to help the user identify where hold time violations may occur. The clock tree, which is rooted at the clock source, is the part of the user's design that calculates the values of clock input pins of flip-flops and other storage elements. The prior art emulation compiler identifies the clock tree by tracing backwards in the circuit from flip-flop clock pins until it reaches a clock source of the design. In some designs, this backward tracing will include a large amount of irrelevant circuitry, because the software has no mechanism for inferring that parts of the backward cone are irrelevant for timing purposes. There are several methods for the user to identify which parts of the clock tree are irrelevant. The most basic mechanism is the clock qualifier. When a user marks a net of the design as a clock qualifier, it indicates that the net is NOT part of the clock circuit. The user may need to mark many nets as clock qualifiers so that the prior art software can compile the design successfully. The reason for this is that the clock trees may require too many pins and/or logic gates to duplicate in one logic chip (e.g., field programmable gate array). Performing clock qualification is a time consuming activity. Some emulation system users spend multiple weeks performing clock qualification. Moreover, if a user identifies functional errors during emulation and makes changes to the circuit design, it may become necessary to perform the clock qualification procedure again.

When a user selects a net to be a clock qualifier, the user is stating that the net is not part of the clock tree. In user designs utilizing gate clocks, clock trees with tens of thousands of instances can result. In prior art emulation software, the software will supply “suggested” clock qualifiers after it has created and analyzed the clock trees. However, emulation software could possibly identify thousands of potential clock qualifiers. One approach the user can take to reduce the amount of time it takes to get to emulation is simply to accept all the suggested clock qualifiers. This reduces the size of the clock tree, but may cause problems for clock tree generation software because when it tries to trace back some of the clock pins, it may hit a wall of clock qualifiers. When this happens, the clock tree generation software will still find a clock path, by ignoring one or more clock qualifiers. However, this may cause the software to identify a clock path that is incorrect. If the design does not emulate correctly, the user has no way of knowing if it is a problem with the design, or whether the clock tree computation is in error unless the user debugged the emulation models.

The prior art method of eliminating hold time violations, disclosed in U.S. Pat. No. 5,475,830, operated as follows. As disclosed in U.S. Pat. No. 5,475,830, the prior art used many strategies for eliminating hold time violations. One strategy was to duplicate clock-tree logic throughout the programmable logic chips in the emulation system. This reduced the issues associated with sending clock signals to many different logic chips, thereby significantly reducing clock skew. A second strategy was for the emulation software to use the clock tree information to insert delay elements into the user's design (which are only used during emulation—they are not a part of the user's actual design). It is important to reiterate that clock tree duplication and delay insertion methods of the prior art are performed while the user's design is being compiled.

Two flip-flops having the relationship like the one shown in FIG. 1 are said to be a “hold-time concerned pair”. When the two flip-flops of a hold-time concerned pair are placed on different chips by the emulation system's partitioner, it is unlikely a hold-time violation will occur because the clock logic has been duplicated on the chips. The reason for this is that the data signal between flip-flop FF1 10 and flip-flop FF2 12 travels between two chips, which introduces the delay needed to prevent the hold-time violation. On the other hand, if the flip-flops are placed on the same chip, the chip partitioner marks flip-flop FF2 12 for additional delay on its input if there is logic in the clock path between flip-flops 10, 12 or if the flip-flops 10, 12 are fed by a common clock source through clock logic.

Clock tree analysis presents serious problems in the prior art emulation compiler. The first is that the clock tree analysis software makes the emulation software more complex. This complexity makes the software more error-prone and more costly to maintain. A second and more serious problem is that clock tree analysis increases time to emulation.

There are two places in the prior art compiler flow where clock tree analysis is performed. The first time is during clock analysis and the second time is during partitioning. Even though an overlap in functionality exists between these two important functions, current emulation software does not share any programming code. The clock analysis software is relatively fast, but still contributes to the elapsed time of compilation. The clock tree analysis that takes place during partitioning can take considerably longer than the similar clock tree analysis taking place during the clock analysis. The reason for this is that the partitioning software identifies flip-flops that are hold-time concerned pairs. Experience has shown that some designs require tens of minutes of CPU time for clock tree analysis when partitioning a design. A compilation flow that does not require the partitioner to perform clock tree analysis would reduce the amount of time it takes an emulation system to compile a user's design.

Because of the problems associated with clock tree analysis and the undesirability of having the user manually identifying clock qualifiers, there is a need for a new method of compiling designs for use in a hardware emulation system to eliminate hold time violations while decreasing compile time and reducing the amount of user intervention required.

### SUMMARY OF THE INVENTION

Instead of analyzing the clock tree and computing where to insert delays, a new compilation flow will instead put an adjustable delay at the input of all flip-flops in a user's design. By adjusting the amount of delay at emulation-time, hold-time violations can be remedied.

The above and other preferred features of the invention, including various novel details of implementation and combination of elements will now be more particularly described with reference to the accompanying drawings and pointed out in the claims. It will be understood that the particular methods and circuits embodying the invention are shown by way of illustration only and not as limitations of the invention. As will be understood by those skilled in the art, the principles and features of this invention may be employed in various and numerous embodiments without departing from the scope of the invention.

### BRIEF DESCRIPTION OF THE DRAWINGS

Reference is made to the accompanying drawings in which are shown illustrative embodiments of aspects of the invention, from which novel features and advantages will be apparent.

FIG. 1 is a schematic diagram illustrating a generic logic circuit employing both sequential and combinational logic elements.

FIG. 2 is a schematic diagram illustrating the generic logic circuit of FIG. 1 having an adjustable delay element inserted in the data path.

FIG. 3 is a schematic diagram of a presently preferred logic element found in a logic chip installed in a hardware emulation system.

FIG. 4 is a schematic diagram of an adjustable delay element.

### DETAILED DESCRIPTION OF THE DRAWINGS

Turning to the figures, the presently preferred apparatus and methods of the present invention will now be described. The various embodiments of the present invention provide new methods for compiling user designs in hardware emulation systems. These new methods make the compilation process much easier for users that have designs with large, complex clock trees.

The various embodiments of the present invention can make changes to the user's netlist. These changes include modifying the user's design after it has been compiled for emulation by inserting adjustable delay elements into the data-input net of all flip-flops. The purpose of inserting the delay elements is to insure timing correctness.

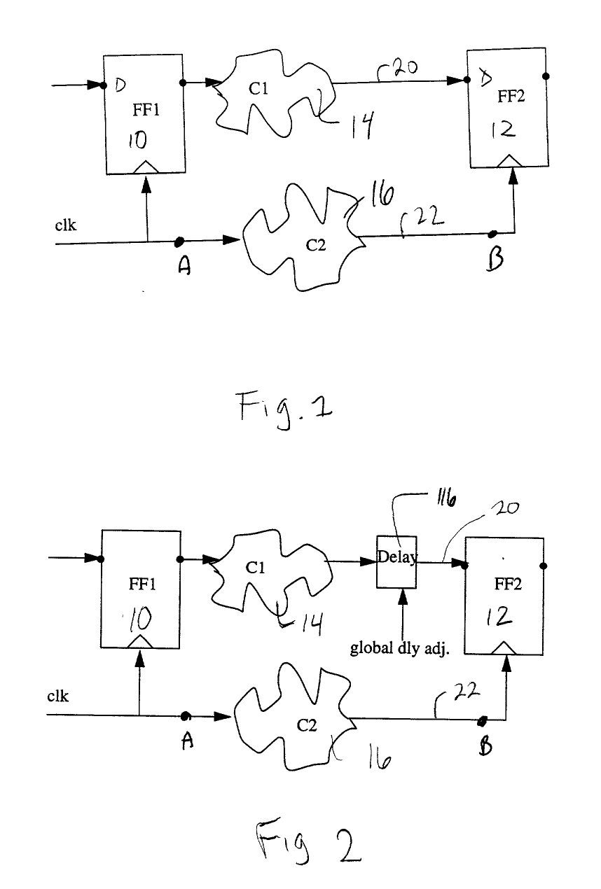

In one embodiment of the present invention, a globally adjustable delay element 116 is inserted at the input to all registers after the design has been compiled. An example of how a user's design is modified in the fashion is shown in FIG. 2, which is a modified version of the user design shown in FIG. 1. In the various embodiments of the present invention, the user's design, e.g., the circuit of FIG. 1, is first compiled by the emulation system software to create an emulation netlist appropriate for implementation in the emulation system itself. After compilation, but before the emulation system is programmed, the emulation netlist is modified by the insertion of adjustable delay element 116 at the data input to flip-flop FF2 12. Thus, adjustable delay element 116 is disposed between logic network 14 and flip-flop FF2 12. As will be discussed in more detail below, after the adjustable delay elements are implemented in the emulation system, the user will set the amount of delay that the adjustable delay elements will cause. By adjusting the amount of delay, hold-time violations can be eliminated.

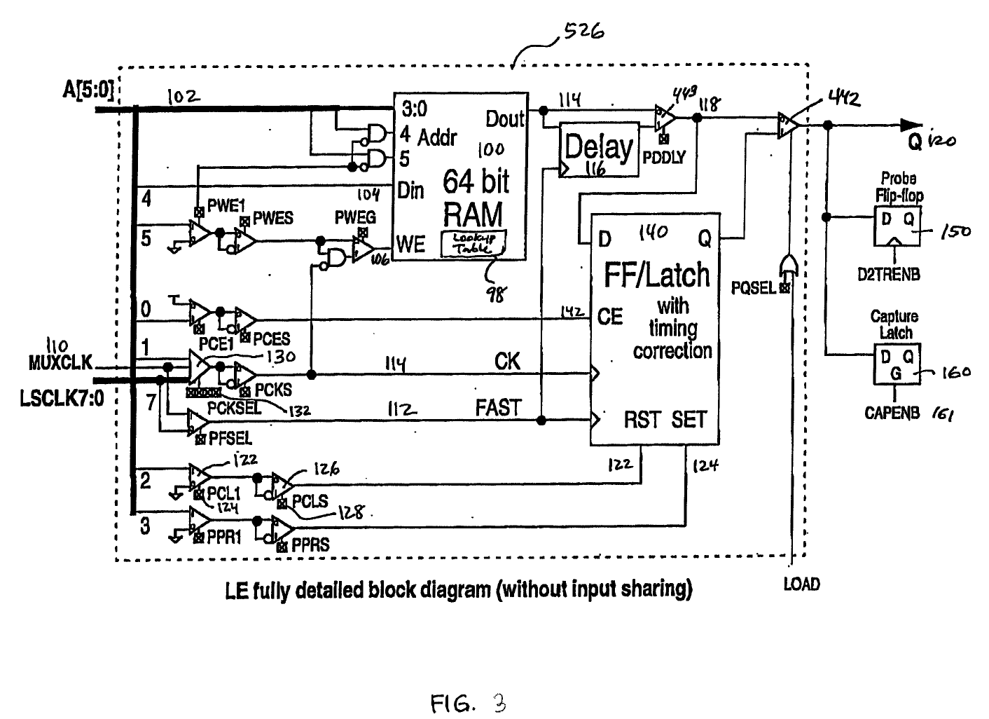

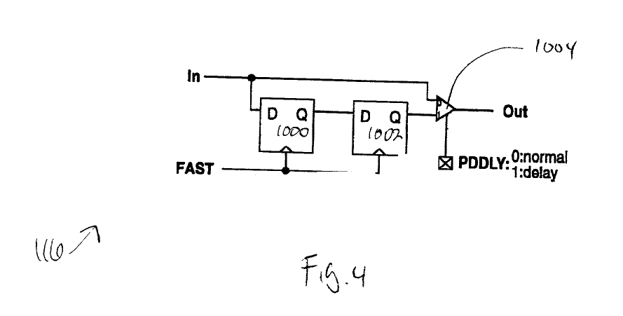

FIG. 3 illustrates a logic element LE 526 built in accordance with one embodiment of the invention. Logic element 526 is described in more detail in U.S. patent application Ser. No. 09/570,142, discussed above. The logic element 526 includes a 64 bit RAM 100, a lookup table 98 in the RAM 100, an delay element 116 and a programmable flip-flop/latch 140. Connected to the logic element 526 are a probe flip flop 150 and capture latch 160. There are two clock signals, CK 114 and fast (FAST) clock 112. The 64 bit RAM 100 receives address bits 102, data input 104, write enable signal 106 and CK clock 114. The flip-flop/latch 140 receives data 118, active-high clock enable signal 142, clock CK 114, FAST clock 112, asynchronous reset signal 122 and asynchronous set signal 124. The six inputs to the logic element 526 supply address bits to the lookup table 98 which outputs a data bit output 114. Although the inputs to the logic element 526 are typically data bits, they can also be used as clocks. For example, a logic element input signal may be used to clock the flip-flop/latch 140 whenever that signal is activated. Input multiplexers such as multiplexer 122 and the programming bit 124 used to select the value of RESET signal 122. Likewise, input multiplexer 126 is controlled by programming bit 128 and input multiplexer 130 is controlled by multiple programming bits 132. Hence, input multiplexers control the state of the CK clock signal 114, clock enable signal 142, SET signal 124 and RESET signal 122 to the flip-flop/latch 140. A processor may write the configuration bits into the RAM, or alternatively, an EPROM.

In this particular embodiment, the lookup table 98 is a static random access memory (SRAM) that performs any combinational function involving up to six variables. The combination of a lookup table 98 and input multiplexers to control the flip-flop/latch 140's CK clock signal 114, clock enable signal 142, RESET signal 122 and SET signal 124 results in a logic element 526 whose inputs may be freely swapped to carry any signal. For example, a given signal may be transmitted on any one of the six logic element input lines, thereby creating a flexible logic element that can implement a given function in a variety of ways. When logic element inputs are swapped, the contents of the lookup table 98 are altered accordingly so that the logic element can implement the same function. Similarly, when logic element inputs that control an input multiplexer (CK clock, clock enable, reset or set) are swapped, the configuration bits that control the multiplexer are changed to reflect the swapped inputs. Such flexibility of the use of each input to the logic element 526 also results in better routability of the higher level blocks (such as the L1 and L2 blocks). Using these logic elements 526, almost any combinational or sequential logic function can be implemented. Logic elements 526 may also be swapped freely during L0 routing to perform a given function.

The delay element 116 receives the data output 114 from the RAM 100 and is clocked by FAST clock 112. FAST clock 112 is analogous to the MUXCLK disclosed in U.S. Pat. No. 5,960,191. The flip-flop/latch 140 may act as either a latch or a flip-flop, depending on the function being implemented by the logic element 526. A flip-flop transfers the data on its D input line to the Q output line on the edge of a clock signal; whereas, a latch continuously transfers data from the D input line to the Q output line until the clock signal falls low. The data-in multiplexer 443 allows the delay generated by delay element 116 to be selectively inserted into the data stream. The flip-flop/latch 140 can be preloaded with data. The flip-flop/latch 140 can either be a rising edge triggered flip flop or a transparent latch. Its input is either the output 114 from the RAM 100 or the delayed output from the delay element 116. The output of the data-in multiplexer 443 drives the D input of the flip-flop/latch 140. The Q output of the flip-flop/latch 140 is supplied through the data-out multiplexer 442 to the logic element's output pin 120, where the Q output may travel to other logic elements within the same L0 logic block or exit the L0 logic block to the X1 crossbar network.

The flip/flop latch 140 is used when needed for the logic element 526 to implement a particular function. For example, when the logic element 526 simply implements a pure combinatorial function provided by the lookup table 98, the flip-flop/latch 140 may be unnecessary. The Q output from the flip-flop/latch 140 goes to the logic element's output pin 120. The output of the data-in multiplexer 443 can be supplied directly through the data-out multiplexer 442 to the logic element's output 120, thereby bypassing the flip-flop/latch 140. Thus, the Q output 120 of the logic element 526 is programmable to select the output 114 from the RAM 100 directly (with or without the delay added by delay element 116) or the output Q from the flip-flop/latch 140. By transmitting the RAM memory output 114 through components of the logic element 526 (rather than directly) to the X0 interconnect network, additional X0 routing lines are not required to route the memory output. Instead, the RAM memory output 114 simply and advantageously uses part of a logic element 526 to reach the X0 interconnect network. Likewise, the RAM 100 can use some of the logic element's input lines to receive signals and again, additional X0 routing lines are not necessary. Moreover, if only some of the six logic element inputs are consumed by the memory function, the remaining logic element inputs can still be used by the logic element 526 for combinatorial or sequential logic functions. A logic element 526 that has some input lines free may still be used to latch data, latch addresses or time multiplex multiple memories to act as a larger memory or a differently configured memory. Therefore, circuit resources are utilized more effectively and efficiently. This logic element design offers increased density, ease of routability and freedom to assign connections to logic element inputs as needed. This logic element design further provides easy routability with a partially populated crossbar instead of a full crossbar.

The CK clock signal 114 acts as the clock signal to the flip-flop/latch 140 which causes the flip-flop/latch 140 to transfer data from its D input line to its Q output line. The clock enable signal 142 allows the flip-flop/latch 140 to respond to the CK clock signal 114. The RESET signal 122 clears the flip-flop/latch 140 and resets the Q output of the flip-flop/latch 140 to zero. The SET signal 124 sets the Q output of the flip-flop/latch 140 to one.

When the PDDLY programming bit is 1, the delay element 116 adds a delay to the datapath output. Because the delay element 116 is clocked by the FAST clock 112, the amount of delay can be precisely controlled. Because the logic element 526 has adjustable delay element 116 built in, use of the method of eliminating hold time violations disclosed herein does not require the use of the logic resources of the logic elements 526. Because of this, use of the methods disclosed herein does not significantly increase the number of logic chips necessary to implement a user's design in an emulation system.

One exemplary embodiment of the delay element 116 is shown in FIG. 4. The adjustable delay element shown in FIG. 4 comprises a first flip-flop 1000 in series with a second flip-flop 1002. In a presently preferred embodiment first flip-flop 1000 and second flip-flop 1002 are edge-triggered flip-flops. First flip-flop 1000 and second flip-flop 1002 are clocked by the FAST clock 112 discussed above. The output of second flip-flop 1002 is input to a multiplexer 1004. In the prior art, the user would evaluate the clock trees created by the clock analysis software and decide whether to use adjustable delay element 116. The user would then have to adjust the amount of delay introduced by the delay element 116. The delay is set by varying the period of the FAST clock 112.

In another embodiment of the present invention, globally adjustable delay elements 116 are not inserted at the inputs to all registers. Instead, after compilation, the data path delay and the clock skew for all the hold-time concerned pairs (see, e.g., FIGS. 1 and 2) is calculated. For those hold-time concerned pairs where the data path delay is greater than the clock skew, no data path delay is necessary and therefore adjustable delay elements 116 are not inserted into the user's design at those flip-flops. An advantage of this particular embodiment is that in circuit speed (i.e., emulation speed) may be faster. A disadvantage to this embodiment is that the logic elements in the logic chips (e.g., field programmable gate arrays) may need to be reprogrammed after compilation to remove the adjustable delay elements 116 that were inserted.

In contrast with the prior art, the various embodiments of the present invention either do not perform clock tree analysis or significantly reduces the amount of clock tree analysis that takes place. In the presently preferred embodiment, no clock tree analysis takes place. Thus, in the presently preferred embodiment, the emulation system's compiler does not duplicate clock trees for each programmable logic chip and does not insert delay elements between hold time concerned pairs of sequential logic elements. Using the embodiments of the invention, the user's design is first compiled into an emulation netlist. During compilation, the software modifies the emulation netlist and places adjustable delay element 116 at the data input to every sequential logic element of a user's design. Then, the user experiments with the amount of delay that should be programmed into adjustable delay element 116.

The user should use the following guidelines for selecting the amount of delay to be programmed into adjustable delay element 116. One method is as follows and is based upon the assumption that the hold time delay needed to compensate clock skew is the maximum skew between any two clock nets driving two storage elements that is on the data path of one or another.

To estimate the clock skew through the datapath, a clock tree is built between clock sources and clock nets, where intermediate nodes are common ancestors of some clock nets. The first step in this method is to compute the delay between between any two connected nodes (an edge) in the clock tree (referred to as “pathDelay(A, B)”), where the delay can be derived after place and route to be more accurate. For any two clock nets A and B (see FIGS. 1 and 2), PathSkew(A, B) is the difference between the max path delay from a common ancestor to node A and B. This can be easily derived from the clock tree with PathDelay defined on all edges.

The amount of holdtime delay needed for each flip-flop can be computed as follows:

1. Trace back from the data path of the flip-flop 12 to reach all storage elements or primary inputs. This results in the identification of hold-time concerned pairs of flip-flops.

2. Find the set of clock nets driving these storage elements or primary inputs (these clock nets are referred to herein as “DrvClkSet”).

3. The maximum hold time delay, (referred to as “HoldTimeDelay(12)”), for the delay element in front of the flip-flop equals the maximum PathSkew(A, B), where A is a clock net in DrvClkSet, and B is a clock net of the flip-flop 12 that is the root of the back-tracing.

It is noted that when a uniform delay needs to be set for an emulation system, it could be set as the max HoldTimeDelay(X), where X is any storage element in the system.

A second method for setting the delay of the adjustable element is as follows. This second method only requires clock tree analysis (after compilation). This method is based upon the assumption that the hold time delay needed to compensate for clock skew is the difference between the longest and shortest path delays of any clock net from any clock source.

With a worst case assumption that there exists a data path from any storage element to any other storage element, the hold time delay needed to compensate for clock skew is the maximum difference in arrival time for any two clock nets from a certain clock source. Therefore, the system hold time delay can be set as the longest path delay from any clock source to any clock net minus the shortest path delay from any clock source to any clock net.

In sum, the amount of delay added by adjustable delay element 116 should make the total delay between the output of flip-flop FF1 10 through logic network C1 14 to the input of flip-flop FF2 12 greater than the sum of the required hold-time for flip-flop FF2 12 plus the delay caused by logic network C2 16.

The amount of delay to program into the adjustable delay element 116 is calculated as follows and with reference to FIG. 2. After the compilation of the design, logic network C2 16 in the clock path was partitioned for programming into C logic chips. The clock skew between FF1 10 and FF2 12 is calculated by summing all the internal chip delays of those C chips (this value will be referred to as “CI”) caused by logic network C2 16 and the delays of all chip hops (this value will be referred to as “CH”) caused by logic network C2 16.

Likewise, logic network C1 14 in the data path was partitioned for programming into D chips. The total delay between the output of FF1 10 to the input of FF2 12 is calculated by summing up all internal chip delays of those D chips (this value will be referred to as “DI”) caused by logic network C1 14 and the delays of all chip hops (this value will be referred to as “DH”) caused by logic network C1 14.

For calculation purposes, I(CI, CH, DI, DH) is the delay that should be inserted in order to remove the hold-time violation.

Thus, to prevent hold-time violations, the following inequality must be met:

DI+DH+I(CI, CH, DI, DH)>CI+CH

This means that:

I(CI, CH, DI, DH)>CI+CH−(DI+DH)

It should be noted that if:

DI+DH>CI+CH,

it is not necessary to program any delay into adjustable delay element because there should not be a hold-time violation.

Alternative partitioners do not necessarily guarantee hold-time correctness. Thus, some form of post-processing may be necessary in the compilation flow. Using the various methods of the present invention with the adjustable-delay insertion method can make alternative partitioners hold-time correct.

[Dennis: Review this:]

The adjustable delay element 116 is programmed as follows. As seen in FIG. 4, the adjustable delay element 116 is comprised of flip-flop 1000, flip-flop 1002 and multiplexer 1004. The desired delay is implemented by first, setting the PDDLY to one. This sets the multiplexer 1004 to select the output of flip-flop 110. Otherwise, flip-flops 1000 and 1002 are not placed in the circuit and no delay is implemented. When PDDLY is set to one, the data path signal will necessarily pass through the two flip-flops 1000 and 1002. These flip-flops 1000 and 1002 have inherent delay. Moreover, the amount of delay is implemented by varying the frequency of the FAST clock. Thus, the delay becomes one cycle of the FAST clock, plus a small amount of delay caused by flip-flops 1000 and 1002.

It should be noted that in another embodiment of the present invention, unnecessary adjustable delay elements 116 can be removed (i.e., setting PDDLY to zero) from some LE's after path delay calculations by reprogramming those chips where delay elements are not needed (i.e., where there is not a hold time concerned pair).

Thus, a preferred method and apparatus for emulating and verifying an integrated circuit has been described. While embodiments and applications of this invention have been shown and described, as would be apparent to those skilled in the art, many more embodiments and applications are possible without departing from the inventive concepts disclosed herein. The invention, therefore is not to be restricted except in the spirit of the appended claims.

We claim:

1. A method of compiling a netlist description of a logic design for programming into a hardware logic emulation system, the netlist description comprising combinational logic gates, sequential logic gates, data paths and clock paths, the sequential logic gates comprising flip-flops and latches, each of the flip-flops comprising a data input, a clock inputs and an output, the method comprising:
compiling the netlist description to create an emulation netlist, said compiling step comprising:
identifying every flip-flop in the emulation netlist;
changing the emulation netlist such that an adjustable delay element is disposed at the data input of each of the flip-flops of the netlist description; and
after said compiling step, setting a delay for said adjustable delay element to a value that eliminates the possibility of a hold time violation.

2. The method of claim 1 wherein said adjustable delay comprises a first flip-flop and a second flip flop, wherein said first flip-flop has an input, an output and a clock input, said second flip-flop has an input, an output and a clock input, said output of said first flip-flop in communication with said input of said second flip-flop.

3. The method of claim 2 wherein said delay is established in said adjustable delay element by varying frequencies input to said clock input on said first flip-flop and to said clock input on said second flip-flop.

4. A method processing a netlist description of a logic design for programming into an emulation system that eliminates hold time violations, the netlist description comprising combinational logic gates, sequential logic gates, data paths and clock paths, the sequential logic gates comprising flip-flops and latches, each of the flip-flops comprising a data input, a clock inputs and an output, the emulation system comprised of programmable logic chips interconnected together, the method comprising:
compiling the netlist description to create an emulation netlist, said compiling step comprising inserting an adjustable delay element at the data input of each of the flip-flops of the netlist description;
calculating data path delay time and clock path delay time, the clock paths and data paths may be passing through multiple of the programmable logic chips;
calculating clock skew value between a pair of flip-flops; and
setting a delay value for said adjustable delay element that makes said data path delay greater than said clock skew.

5. The method of claim 4 wherein said adjustable delay comprises a first flip-flop and a second flip flop, wherein said first flip-flop has an input, an output and a clock input, said second flip-flop has an input, an output and a clock input, said output of said first flip-flop in communication with said input of said second flip-flop.

6. The method of claim 5 wherein said delay is established in said adjustable delay element by varying frequencies input to said clock input on said first flip-flop and to said clock input on said second flip-flop.

7. The method of claim 4 further comprising removing selected ones of said adjustable delay elements from the netlist description where said data path delay already greater than said clock skew without setting said delay value.
